(19) United States
(12) Patent Application Publication
(10) Pub. No.: US 2013/0311387 A1
(43) Pub. Date: Nov. 21, 2013

(54) PREDICTIVE METHOD AND APPARATUS TO DETECT COMPLIANCE RISK

(71) Applicant: Jurgen Schmerler, Solana Beach, CA (US)

(72) Inventor: Jurgen Schmerler, Solana Beach, CA (US)

(21) Appl. No.: 13/861,184

(22) Filed: Apr. 11, 2013

Related U.S. Application Data
(60) Provisional application No. 61/625,893, filed on Apr. 18, 2012.

(51) Int. Cl. G06Q 30/00

(52) U.S. Cl. CPC G06Q 30/018
USPC 705/317

(57) ABSTRACT

A predictive model provides a detection system for the risk associated with organizational representatives of an organization not being in compliance with laws, regulations, and organizational policies. The system produces a score, which measures the likelihood of non-compliance for organizational representatives, larger organizational units, or the entire organization. The predictive model is part of a system that analyzes individual interactions between representatives and their counterparts outside the organization for scoring. The system stores data about these interactions in a database, which is used to derive variables for the predictive model, and processes the model outputs.

### RELATED ART

This application claims priority to U.S. Provisional Patent Application 61/625,893 filed on Apr. 18, 2012.

### BACKGROUND

1. Field of the Invention

Aspects of the disclosure relate in general to the detection and assessment of behaviors of individual representatives of an organization that increases risk of regulatory non-compliance to such organization. In particular, the disclosure relates to an automated risk detection system using predictive modeling (statistical analyses) in order to identify individuals or their organizational units, who are at high risk of non-conformity of government regulations and company policies.

2. Description of the Related Art

Risky behaviors of individual representatives and organizational units of organizations have the potential for massive adverse consequences to the affected organization. Whether the underlying intention of such behavior is fraud or negligence, organizations will be well-served by a timely detection of problematic patterns that could result in an increased compliance risk.

Some industries are under elevated scrutiny, for instance, the pharmaceutical and medical device industry, the financial industry, or export-oriented industries.

Major compliance risk areas can be grouped into two categories; internal operations compliance and external operations compliance. Internal operations compliance often includes the process of how goods and services are provided. In the pharmaceutical industry that would be primarily the compliance with Good Manufacturing Practices legislation and industry guidelines. External operations compliance could be understood primarily as Commercial Compliance in the private sector. Commercial Compliance addresses outward activities, communications, and reporting of organizations and includes, for instance, areas of:

Marketing Compliance

Sales Compliance

Consumer Protections Compliance, and

Financial Compliance, including Sarbanes-Oxley regulations.

Each of these areas has again a wide variety of regulations and policies that further sub-divide them. As an example—and probably the most financially impactful area in the pharmaceutical industry—Sales Compliance includes regulations and policies addressing Off-Label Marketing, Expense Reporting (regulated in the so-called “Sunshine Act” part of the Affordable Care Act), Foreign Corrupt Practices Act (FCPA), Sample Management, and Sales Representatives' Call Plan adherence. Fines assessed on the pharmaceutical industry for Off-Label Marketing infractions alone exceeded $7 billion in 2012 with a rising tendency.

To further substantiate the origins of the disclosure and to exemplify the use of this disclosure, Off-Label Marketing risk to pharmaceutical companies will be used to illustrate the background of this disclosure.

A growing number of companies have been investigated for engaging in illegal off-label marketing, with the total combined value of the settlements reaching billions of dollars.

Though physicians may prescribe drugs for off-label usage known as off-label marketing, the Food and Drug Administration (FDA) prohibits drug manufacturers from marketing or promoting a drug for a use that the FDA has not approved. A manufacturer illegally “misbrands” a drug if the drug's labeling includes information about its unapproved uses. A drug is deemed misbranded unless its labeling bears adequate directions for use. The courts have agreed with the FDA that the Food, Drug, and Cosmetic Act (FDCA) requires information not only on how a product is to be used (e.g., dosage and administration), but also on all the intended uses of the product. In 2004, whistleblower David Franklin prevailed in a suit under the False Claims Act against Warner-Lambert, resulting in a $430 million settlement in the Franklin v. Parke-Davis case. It was the first off-label promotion case successfully brought under the False Claims Act in U.S. history. Oral statements and materials presented at industry-support scientific and educational activities may provide evidence of a product's intended use. If these statements or materials promote a use that is inconsistent with the product's approved labeling, the product is misbranded under the FDCA for failure to bear labeling with adequate directions for all intended uses.

Historically, sales representatives of pharmaceutical companies were measures primarily on their quantitative sales performance. There is an obvious conflict in that approach with a serous desire to prevent off-label marketing and promotion, since these additional uses of a product can increase sales volume dramatically. In recent years, due primarily to increased law enforcement action and large monetary fines, pharmaceutical companies are adopting stronger policies to avoid off-label marketing. These policies, however, lack effective mechanisms of enforcement. Usually, companies rely on additional education of their representatives and disciplinary actions if non-compliance is discovered. Non-compliance now often leads to immediate dismissal of the offending representative.

Such a blunt approach holds obvious drawbacks; non-compliant behavior is still impossible to predict, hard to detect, and the threat of severe actions leads to less-productive sales meetings by representatives for fear of punishment.

It is this environment and the lack of fine-tuned compliance enforcement tools that generated the idea of using a technological approach for creating a more compliant yet productive environment for organizational representatives.

This disclosure is possible now that the computing world is shifting to a cloud-based, decentralized computing model with the capacity of managing large amounts of data generated by many small devices that are constantly connected with each other.

To predict and avoid potential non-compliance it is necessary to integrate data from

Representatives' sales interactions,

Organizational departments like marketing regulatory affairs, and quality assurance,

Post sales feedback data,

Industry databases, and

Comparative historical data sources.

Historically, there have been no automated statistical-based tools that assist compliance officers and organization managers in identifying suspicious representative behaviors for further investigation into non-compliance. Accordingly, it is desirable to have an automated system that uses available information regarding representatives' behaviors and highlight behaviors that increase the risk of non-compliance. Such a system should enable an organization to prioritize behavioral patterns, individual representatives, or even whole organizational units for further scrutiny into potential non-compliance with laws and policies. At the same time, such a system would allow compliant representatives to operate with greater degrees of freedom because of a proven record of compliant interactions.

The effectiveness of such a system depends on its ability to handle a large number of independent variables. In addition, the long-term effectiveness and the predictive value of such a system depend on the capacity for readjustment of the underlying detection techniques as new patterns of non-compliant behavior emerge.

### SUMMARY

Embodiments include a system, device, method and computer-readable medium for detecting behaviors by organizational representatives that are not compliant with policies, laws, or regulations the organization is subject of, where the representative is acting on behalf of an organization in interactions with customers, suppliers, regulators, employees, or other stakeholders of the organization. One or more computing systems select one or more electronically recorded interactions to process with a predictive model; for each selected representative, deriving variables from the interactions in connection with the selected representative. For each selected representative, the system applies the delivered variables of the interactions to the predictive model to generate a model score indicating the relative likelihood of non-compliant behavior.

### BRIEF DESCRIPTION OF THE DRAWINGS

FIG. 1 is an illustration of potential non-compliant interactions of organizational representatives in the pharmaceutical industry.

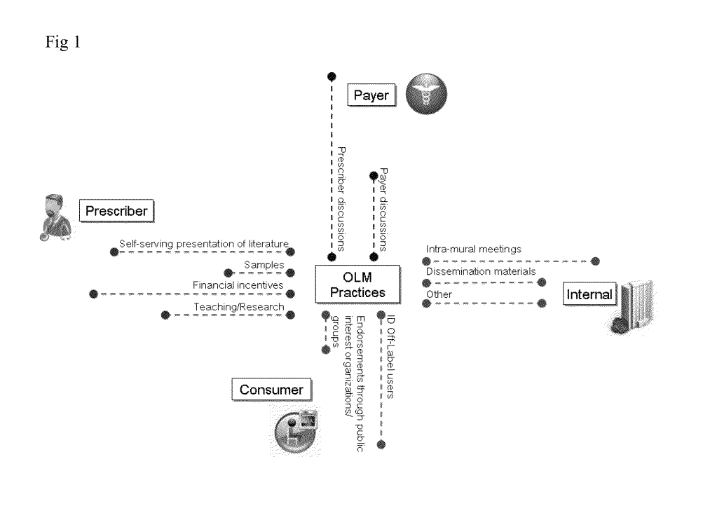

FIG. 2 is an illustration of the conceptual model of compliance risk detection by the present disclosure.

FIG. 3 is an illustration of a compliance audit trail in the context of off-label marketing.

FIG. 4 is a diagram of the functional operation of the present disclosure.

FIG. 5 is a outlines the software architecture of one embodiment of the present disclosure.

### DETAILED DESCRIPTION

The present disclosure is designed to provide these desired features by applying advanced analytical and statistical methods in the context of an automated system to identify those organization representatives or organization units that pose an elevated risk of non-compliance to the company, for instance, engaging in off-label marketing practices. The present disclosure includes automated systems, methods, and software products that identify the likelihood non-compliance behaviors for each company representative. The system derives variables that capture relevant features about external interactions, such as visits with physicians. These variables are analyzed using detection methods such as models and rules for patterns indicative of non-compliant conduct.

While wording in this disclosure references the pharmaceutical industry and maybe draw examples from life-science-related subjects, the general concern of Compliance is prevalent in many industries, for profit and non-profit enterprises, non-governmental, as well as governmental organizations. Basically, any entity that has to comply with regulations, which can be a wide variety of internal or external policies and laws, would have a vested interest in measuring its exposure to the risk of non-compliance. Adverse events to non-compliance could include sanctions by authorities, financial damage, or physical harm to customers, patients, or employees.

The present disclosure is able to identify likely non-compliant behavior by learning to distinguish patterns that indicate a compliant interaction from patterns that indicate a non-compliant one. These patterns can be highly complex, involving interactions among many characteristics of the organization, representative, activities, and interaction results. In one embodiment, the present disclosure includes a predictive model that is trained to recognize these intricate patterns using historical examples of compliant, non-compliant, and indeterminately classified (i.e., unknown whether non-compliant or not) interactions. More particularly, the predictive model is trained to recognize these patterns using information about the representative's interaction, information comparing the interaction with interactions of peer representatives, and information comparing the interaction information reported by the representative with the interaction information reported by the recipient, e.g., the visited physician. The predictive model is further trained to consider peer group risk measures which describe the risk of behaviors being non-compliant because it is in a particular peer group.

When a new external interaction by a representative is analyzed by the predictive model, the information about that interaction is compared with the patterns of compliant and non-compliant interactions that the model has learned and the model then assesses the likelihood that representative has engaged in non-compliant behavior. A key characteristic of a statistical model (in contrast to a simple set of guidelines for spotting non-compliance) is that the model assesses all aspects of the interaction simultaneously and considers their interactions. In this way, a statistical or predictive model can achieve a level of complexity in its analysis, accuracy in its assessments, and consistency in its operation that would be nearly impossible for the human brain.

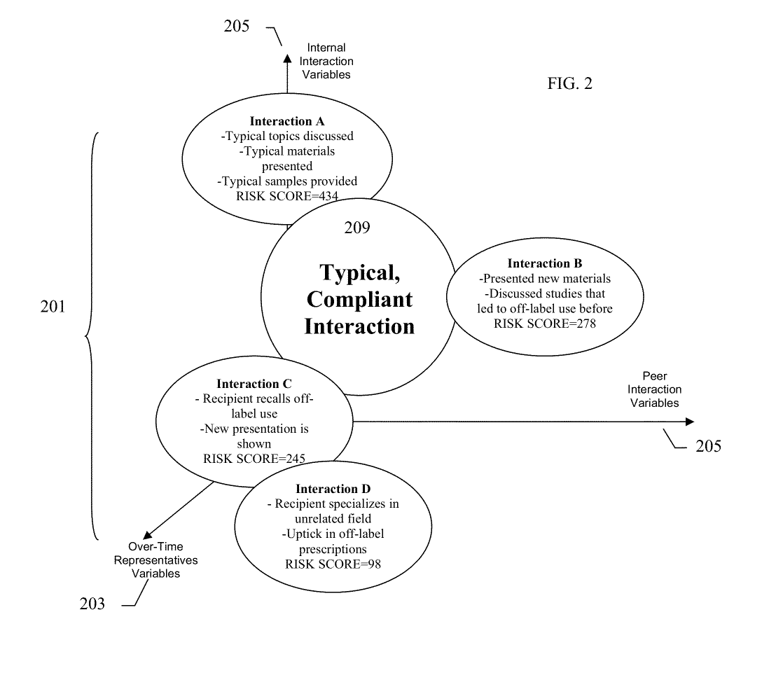

FIG. 2 shows a conceptual diagram of how the predictive model assesses compliance risk. The collection of Interactions, upon which the predictive model is developed, form a complex multi-dimensional “interaction space” 201. This space contains all of the interactions that will be evaluated by the predictive model. For simplicity of representation, this “interaction space” is shown 3-dimensional, but the predictive model can encompass an n-dimensional “space”. That is because each interaction is described by many variables. These interaction variables generally fall into three categories of variables: Over-Time

Representative Variables, 203, Peer Interaction Variables, 205, Internal Interaction Variables, 207. It is this collection of variables that describes each interaction in the interaction space 201. In general, many of these variables may be understood as measures of the amount, distribution, or nature of the activities, behaviors, or characteristics of the organization's representative and their organizational units as indicators of compliance risk.

The peer interaction variables include peer interaction comparison variables and peer interaction risk variables. Peer interaction comparison variables compare an interaction with one or more peer interactions into which the interaction is categorized. The peer interaction comparison variables may be distance measures that describe how far a particular interaction is from a peer interaction average or norm. For example, in the context of off-label marketing, peer interaction comparison variables may compare the distribution of doctors' specializations (i.e., percent of targeted doctors in each of a number of 40 specialization classifications) the pharmaceutical company's business regularly interacts with, with the specialization of the distribution in visited physicians' specialties by one particular sales representative. Any useful statistical comparison measure may be used, such as Z-score, dot product, L1 or L2 norms, or the like.

Peer interaction risk measures describe the risk of non-compliance in the interaction that comes from the interaction taking place in one, or multiple, peer scenarios. For example, certain pharmaceutical product categories pose a higher risk of non-compliance than others (e.g., psycho-pharmaceutical drugs are typically only labeled for use in adults, but are often prescribed by pediatricians). This risk measure is calculated based on historical experience with representatives' interactions in the different peer groupings. When a new interaction is being evaluated, it is categorized into one or more peer groups and the risk measures for these peer interactions are obtained and used as inputs to the predictive model.

Over-time representatives variables compare representatives' interaction data during a selected time period with similar interaction data in a prior time period (or periods). Changes in the interaction data may be indicative of non-compliant behavior. Over time representatives variables may be expressed as percentage changes, distance measures, rates of change, or the like. In the context of off-label marketing, an over-time variable may compare a representative's sales success with her sales numbers in a previous time period.

The peer interaction variables and over-time representatives variables may also compare the non-compliance experience of the representative with its peers or with itself. For example, they may compare a visited physician's recall of an interaction with previous physician assessments (gained through, for instance, follow-up or “post-detail” interviews) or with an average number of recalled off-label uses by peer group visited physicians, or with the response by the same physician in a prior period.

Internal interaction variables are those that are directly reported as a result of the interaction (or derived thereof), and which are evaluated in and of themselves (or in combination) as potential risk factors. For example, internal interaction variables include such factors as physician specialty, number of samples handed out, materials shown, reported off-label discussions, and the like.

The predictive model evaluates all of these types of variables for each interaction. Some of these interaction variables are obtained from the raw interaction data provided by the representative through real-time capturing on an electronic device, some are derived (i.e., calculated) from such raw data, and some are derived from statistical data which has been collected for various peer groups that the representative or the interaction may fall into.

Within the interaction space 201 is a range 209 of interaction variables that describe typical, compliant interactions. This range was learned by the predictive model during model development by processing many examples of interactions which have been classified as either compliant or noncompliant. When the predictive model evaluates a new interaction, it looks at all of the interaction variables together and determines the degree to which the interaction is similar or dissimilar to interactions in the typical interaction range 209. The predictive model assigns a score based on the degree of similarity. The more dissimilar an interaction is from the range of typical interactions, the higher the likelihood of non-compliance in the interaction. The assigned score expresses the relative likelihood of compliance, so that the higher the likelihood of compliance, the higher score.

Most of the interactions look like the typical interactions so they are given a high score, since there is a high likelihood that they are compliant. Interaction A is an example of an interaction that looks typical. All of the variables show that its activity measures and attributes are typical with respect to the three general classes of variables. Thus, Interaction A is shown fairly near the middle of the typical interaction range 209. Accordingly, the predictive model gives Interaction A a high score, indicating a high likelihood of compliance.

Some of the interactions are at the “edge” of the typical interaction space 209. These interactions look a bit more suspicious than the ones closer to the middle and receive slightly lower scores. They have a higher likelihood of being non-compliant than the ones that look more typical. Interaction C is an example of a somewhat suspicious interaction. It is a visit during which the physician was shown a relatively new presentation and she recalled off-label uses for the drug afterwards. That combination of factors raises some suspicions—an internal interaction factor of recalled off-label use, and an over-time representative factor of new material used—but it is not highly suspicious. The model gives Interaction C a medium score of 245.

Interactions that are situated further away from the middle of the typical interaction space 209, are increasingly suspicious interactions. The predictive model gives such interactions lower scores. Interaction D is an example of a highly suspicious interaction. It is a visit to a physician outside the typically targeted specializations by the pharmaceutical company, which is certainly problematic given the narrowly indicated conditions the drug can be promoted for. Thus, Interaction D is atypical when compared to the average interaction of the representative's peer group of physician visits. Adding to the suspicion is the change in the prescriptions (i.e., sales) of the drug for off-label uses originating from prescribers visited by this representative. Thus, Interaction D is also atypical when considering its over-time representative data. This behavior suggests that the representative decided to market the drug for off-label use in violation of federal regulations and corporate policies. The model recognizes this pattern of behavior as indicating a very high likelihood of non-compliance and gives the interaction a score of 98.

Given these various scores, the pharmaceutical company can then rank the interactions by their scores, with Interaction D having the lowest ranking, and then decide which representatives' behaviors to investigate for possible non-compliance. These auditing decisions may be based on the particular model scores assigned using thresholds and criteria established by the organization.

This ability of the predictive model to rank-order interactions by the likelihood of non-compliance is of great value because it enables an organization to catch most of the non-compliant behaviors by following-up only a subset of interactions, (i.e., the lowest-scoring interactions).

In one embodiment as a non-compliance detection system, the present disclosure encompasses the following general processes (each of which is described below):

Interactions are presented to the system;

Some interactions are selected for analysis for non-compliance;

Variables are derived to be used in the analysis;

The selected interactions are analyzed;

Results are generated indicating the likelihood of non-compliance in each selected interaction; and

Results are made available to users.

Interactions may be presented to the system through a fully automated process or through an interactive process. Data on each interaction that is presented is checked to select those interactions that the system can analyze. The specific data to be considered depends on the type of interaction and an organization's operations, but it may include data on the interaction audience, the organization's representative, activity measures, materials used, interaction history, audits or investigations, and any other relevant data. An organization may also manually select interactions for review by the system.

In one aspect of the present disclosure, a scoring period may be defined for the purpose of evaluating the likelihood of non-compliance, and interactions may be selected based on the determination of such a scoring period. The scoring period may be any period of time over which behaviors and interactions are evaluated for non-compliance, whether retrospectively or prospectively. A retrospective scoring period is one defined as a past period. A prospective period is defined in the future (using either estimated future data, or selected past or current data) and seeks to predict if the interaction is likely to become non-compliant in the future.

In a further aspect of the present disclosure, a scoring target may be defined for the purpose of evaluating the likelihood of non-compliance, and interactions may be selected based on the determination of such a scoring target. The scoring target may be any combination of interactions that belong to specific company representatives, to organizational units, or to the whole organization, for which behaviors and interactions are evaluated for non-compliance.

The selected interactions are provided to a detection engine that analyzes each interaction for indications of non-compliance. This process occurs in two steps; First, variables describing the interaction and its activities are derived from the data. As noted above, these derived variables include over-time

representative variables, peer interaction variables, and internal interaction variables. These variables may be based on primary and secondary descriptions of the interaction, the interaction audience, the organization's representative, activity measures, materials used, interaction history, interaction comparables from the industry, and generally provide various measures of the activity related to the interaction.

Once the appropriate variables are derived, they are input into a predictive model. The predictive model has been previously trained to learn the statistical relationships between the derived variables and the likelihood of non-compliance. The predictive model generates a model score indicating the relative likelihood of an interaction indicating non-compliant behavior. The model score is preferably processed into a risk score that indicates the likelihood of non-compliance of the interaction. Optionally, reason codes for each score (highlighting the most important factors in determining the probability of non-compliance) and other information that will aid the organization in using the model scores may also be generated.

Optionally, interactions are analyzed by a separate rule-based analysis that applies expert derived rules to the interaction data and variables to select interactions with indications of non-compliance. These rules preferably identify various significant inconsistencies in the data that are indicative of non-compliance. With Off-Label Marketing, for example, a physician might indicate in a post-detail questionnaire that off-label uses for a drug were discussed with a pharmaceutical representative despite no such notion was mentioned by the representative in describing the interaction. The rule-based analysis outputs a red-flag indicator (or an elevated risk measure, if appropriate), which identifies those interactions suspected of non-compliant behaviors (those that violate the particular red-flag rule). The rule-based analysis may be used to evaluate interactions that were not selected for analysis by the predictive model, thus the combination of approaches (predictive model and rule-based analysis) provides a robust assessment of the likelihood of non-compliance.

The scores provided by the predictive model may be scaled to represent actual probabilities of non-compliance, or to represent a meaningful score that can be compared across the industry.

Once the interactions are scored, the present disclosure enables the users to employ various operational strategies to determine whether or which interactions should be investigated. These strategies may be based on the model score directly, the scaled scores, the number of audits or investigations the staff can perform, the particular goals of the organization, the frequency with which they are willing to audit the same type of interactions, the criticality of compliance for specific operations in the organization, and any other concerns or constraints of the organization. The output of the system may be customized to support usage strategies of individual organizations.

The immediate availability of the compliance risk scores allows an organization to continuously monitor the compliance of it's organizational representatives' interactions. Automatic triggers for an investigation or intervention into potential compliance issues might be set if a risk score crosses a pre-determined threshold. These thresholds can be set at the representative's level or in aggregate for larger organizational units in order to identify larger patterns of non-compliance.

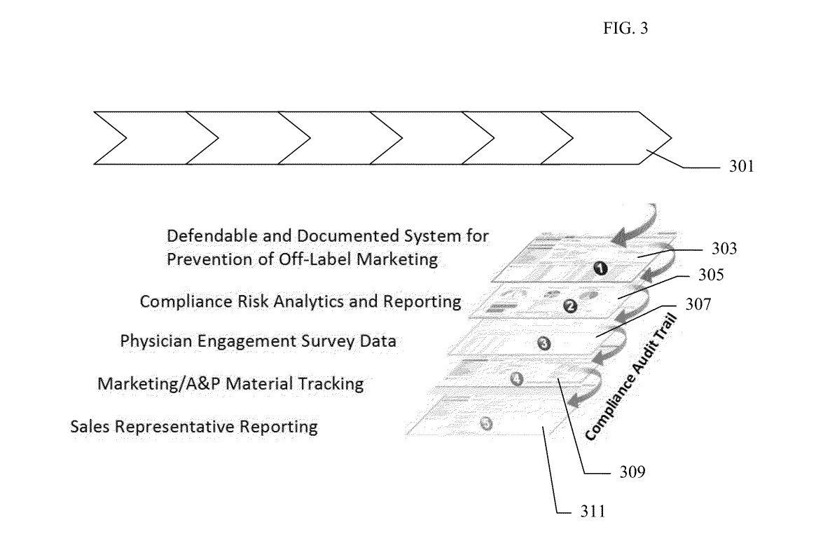

FIG. 3 shows how the present disclosure records the calculated scores and other supporting information to create a Compliance Audit Trail. Each step of a business process, 301, that includes interactions between an organization and an audience, collects pieces of evidence of the compliant nature of the particular interaction, 303. These components of such a Compliance Audit Trail can include the calculated risk score and the results of the rule-based analysis of an interaction, 305, results from secondary sources, such as audience surveys (e.g., Physician Engagement Survey, 307), listings and references to supporting materials used during the interaction, 309, and descriptions of the interaction itself, 311. These descriptions can be provided, for instance, by the organization's representative through a report given during or after the interaction.

The present disclosure provides a number of advantages over traditional non-compliance detection methods. First, the present disclosure identifies individual interactions (through the model scores and rule-based analysis) that have a high likelihood of involving non-compliant behaviors. This presents a significant improvement over traditional detection, which usually identifies non-compliant behavioral patterns over large time periods after damage to the organization has already occurred. The present disclosure allows the organization to address suspected non-compliant behavior immediately and directly before any negative consequences result. The present disclosure further can provide explanations of the model scores to help guide the auditing process and to lead to more compliant organizational processes. The present disclosure may be easily integrated with existing insurer organization databases and compliance programs, and the present disclosure allows the organization great flexibility to develop strategies for using the model scores to select which behaviors to investigate. The present disclosure learns non-compliance patterns from historical examples and improves over time as more examples become available. The present disclosure establishes an audit trail to document compliance for all of an organization's interactions. The present disclosure is easily maintained and updated.

The present disclosure may be embodied in various forms. One embodiment is a software product encompassing various modules that provide functional and structural features to practice the disclosure. One software product embodiment includes a database load process which loads interaction data into a database conducive to the predictive and rule-based analyses, and which may also store results of the analyses. An interaction-selection process retrieves data from the database and selects interactions for analysis. The interaction selection process generates a scoring file, containing parameters that may also define a scoring period for selected interactions during which the likelihood of non-compliance is evaluated. The scoring file is input into a detection engine, which includes a variable derivation process, a predictive model, and an optional rule-based analysis.

The variable derivation process derives from the database the appropriate variables for the selected interactions and provides them as inputs to the predictive model and the rule-based analysis. The variable derivation process may use lookup tables to obtain peer comparison variables, which tables contain statistics (e.g., means, standard deviations, non-compliance rates, etc.,) derived from historical data for selected defined peer groups of interactions. The lookup tables may be dynamically updated as the interaction data from many different interactions changes over time, thereby capturing changes in the risk of non-compliance presented by differing peer groups.

The predictive model embodies the statistical relationships between the derived variables and the likelihood of non-compliance. The predictive model may be a neural network, a multivariate linear regression model, or the like. The predictive model outputs a model score indicative of the relative likelihood of non-compliant behavior. The model score may be scaled into a risk score providing a measure of the probability of non-compliant interactions.

The rule-based analysis analyzes the selected interactions and may additionally analyze interactions that were not selected for scoring by the predictive model. The rule-based analysis identifies interactions that exhibit particular contradictions in their data. Each rule outputs a red-flag indicator (yes/no) or a continuous compliance risk measure for interactions analyzed in aggregate for representatives or organizational units.

A post-scoring process is advantageously used to further enhance the model score information by calculating various score-based measures for rank-ordering interactions. The post-scoring calculations support a variety of usage strategies by providing the organization with a number of different measures by which to determine which interactions to investigate.

Another embodiment of the present disclosure is a system which includes hardware and/or software elements which cooperate to practice the above described functionality and features. Other embodiments include various methods and processes which execute the present disclosure or which may be utilized by an organization to review Compliance of its processes and representatives and select certain interactions for investigation.

A. Functional Description of a Compliance Risk Detection System

In the following description, the present disclosure is described in the context of an exemplary embodiment for detecting the compliance risk of Off-Label Marketing. However, it is understood that the present disclosure is not limited to Off-Label Marketing compliance, and may be used to detect compliance risks for other types of regulations and policies.

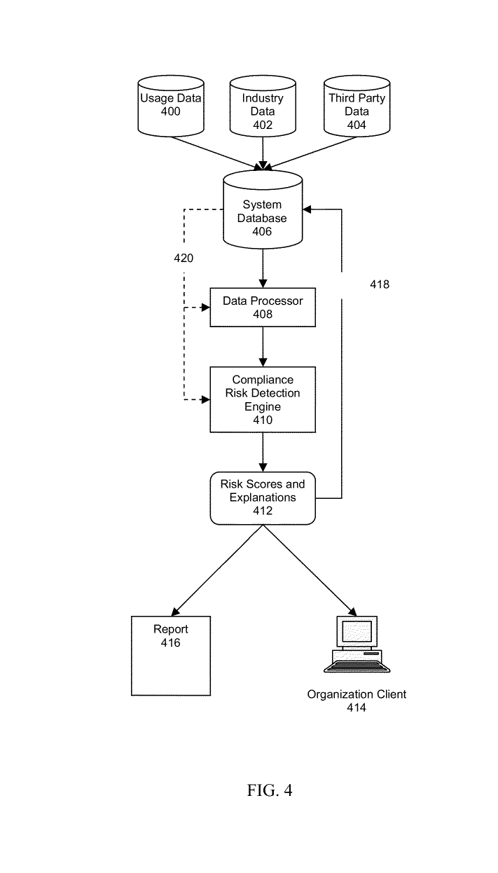

Referring now to FIG. 4 there is shown a functional overview of a compliance risk detection system in accordance with the present disclosure. The process begins with inputs of interaction usage data, 400, industry data, 402, and third party data, 404, provided by an organization. The usage data 400 includes information collected during or after the interaction, for instance, through a mobile device component 528 of the system; the industry data 402 contains information on comparable practices, behaviors, and trends of comparative industry sources (including the own organization); and the third party data, 404, includes data acquired through outside sources, such as follow-up questionnaires and third party databases. The databases are preferably updated as needed by the organization to ensure accurate and timely data for each of the interactions. This information is received on a periodic basis into a system database, 406, where it is appropriately formatted for analysis in accordance with the present disclosure. There are no restrictions on the frequency of the incremental feeds; they could be done monthly, weekly, daily, or even in real-time, depending on the needs of the organization and the specifics of the type of compliance risk being detected. For product standardization, it is preferable that the organization converts the data into a predefined format for input into the system database 406.

For each interaction that is included in the system database 406, or on a user-provided subset of those interactions, the data processor 408 further selects interactions for analysis for non-compliance. If needed, this selection process may establish a period of time (called a scoring period) for which interactions are analyzed. The selection process may further establish the range of selected interactions as they are associated with specific organizational representatives or organizational units (called a scoring target) for which interactions are analyzed. The data processor 408 also derives particular variables from the system database 406 pertinent to the interactions selected.

The derived variables are input into the compliance risk detection engine 410, which applies each interaction to a statistically derived model for non-compliance. The model has been previously trained on a sample of interactions, including both compliant and non-compliant interactions.

In one embodiment, the compliance risk detection engine 410 uses a neural network. Neural networks are advanced statistical tools that have been proven to be effective in learning, from historical data, the patterns of inputs that are most associated with particular behaviors, which can be applied to non-compliant behavior. Neural networks are especially effective at modeling non-linear relationships between input and output, as well as complex interactions between variables. Other types of predictive statistical models may also be used.

The compliance risk detection engine 410 outputs a data file 412 containing a model score for each selected interaction. The model score measures the relative likelihood of non-compliance for an interaction. The model score is preferably scaled into a risk score, which is a measure of the probability that the scoring target has engaged in risky behaviors during the scoring period with regard to compliance. The risk scores are in a predefined range, such as 0-500 (or some other useful range), where a lower score indicates a higher probability elevated compliance risk during the scoring period. In other embodiments, the model score may be scaled to represent the expected risk harm rather than the likelihood or probability of non-compliance. The actual model score, the compliance risk score, for specific interactions, representatives' behavioral patterns, or organizational units are collectively referred to as “scores.”

In addition to the model score, the compliance risk detection engine 410 optionally provides a number of reason codes, or explanations, indicating what aspects of the interactions the model deemed most suspicious. Each reason code corresponds to a group of input variables. These explanations assist the investigator (e.g., Compliance Officer) when investigating interactions or behaviors deemed to be suspicious by directing their attention to specific interaction-related or organizational unit-related facts and data. In one embodiment, multiple reason codes are returned with each model score.

In a preferred embodiment, the compliance risk detection engine 410 also employs an additional rule-based analysis. The rule-based analysis may be used to identify clear-cut cases of potential non-compliance, or to flag suspicious interactions not otherwise assessed by the model.

The scores (and explanations, if any) may then be provided to the organizations and its Compliance Officers either through direct computer access 414 or through printed reports 416. The scores can be used to focus attention towards those interactions or organizational units that warrant further investigations and away from those that are compliant. Various usage strategies for evaluating the identified interactions and units are supported by the present disclosure.

The scores and explanations are also stored 418 in the system database 406 for future use and for the creation of a compliance audit trail, which might later be used as documented evidence of adherence to compliant processes. Finally, based on the periodic updates to the system database 406, the data processor's 408 variable derivation process may be updated 420 to reflect changes in the value of global statistics used to create the input variables (see Peer Group Variables for a detailed description). The compliance risk detection engine 410 may be likewise periodically updated.

In the particular context of off-label marketing risk, the model score is based on an evaluation of discussed topics along with other information about the interaction, including supporting materials used. Since much of this information changes frequently and can vary for each pharmaceutical representative to the next at each physician office visit, most pharmaceutical companies will select a real-time scoring cycle. For other types of compliance risk, a different scoring cycle may be appropriate. The scoring cycle may be adjusted by the organization, as necessary.

B. System Architecture

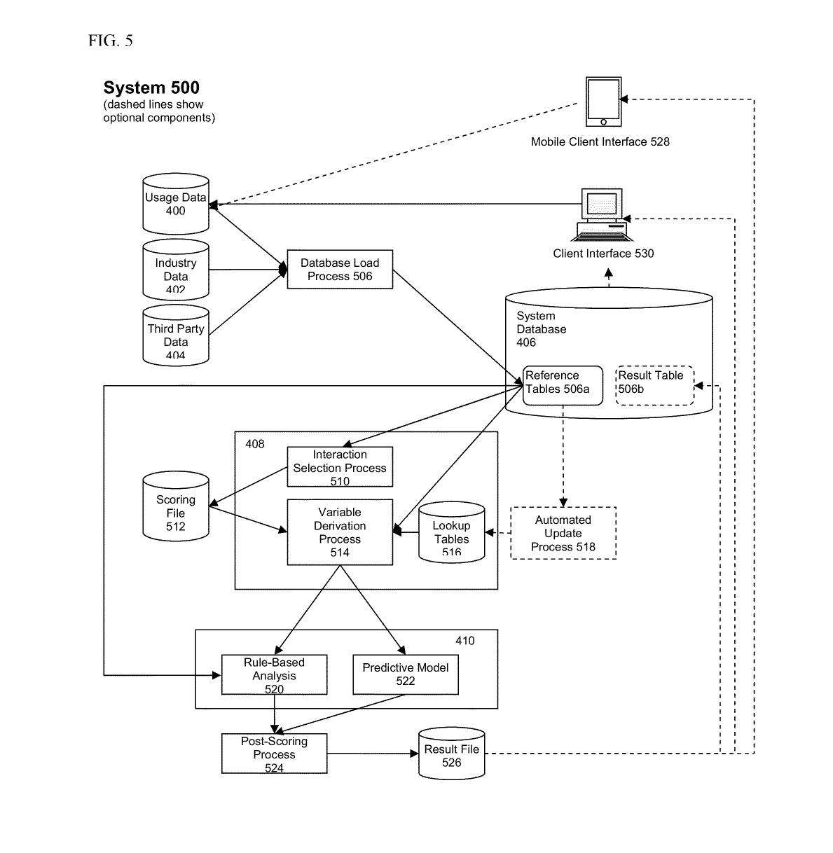

Referring now to FIG. 5, there is shown an illustration of the software architecture for a system 500 for practicing the present disclosure. The illustrated features discussed below are those that are utilized to detect premium fraud and abuse.

The system 500 includes database load process 506, system database 406, interaction selection process 510, variable derivation process 514, lookup tables 516, predictive model 522, rule-based analysis 520, and post-scoring process 524. Relative to FIG. 4, the data processor 408 comprises the interaction selection process 510, the variable derivation process 514 and lookup tables 516; the Compliance Risk Detection Engine 410 comprises the predictive model 522, and the rule-based analysis 520. The system database 406 is accessible through a client interface 530 that enables the insurer to access the results data of the predictive model and rule-based analysis. These various components are preferably provided in a suite of software modules that together form one or more software products.

1. Database Load Process

The usage database 400, industry database 402, and third party database are used as the data source for the system database 406, but their particular formats, contents, and location are expected to vary for different types of compliance events (and possibly for different organizations) and are not material to the disclosure.

When the system 500 is initially deployed, an initial data load from databases 400, 402, and 404 is fed into the system database 406 through the database load process 506. This initial data load includes historical data up to the date of system deployment. On an ongoing basis, new (incremental) data from the usage 400, industry 402, and third party 404 databases are periodically loaded into system database 406 in order to keep the system database 406 up to date.

2. System Database

The system database 406 is structured into a useful arrangement of reference tables 506a that are used as the data source for the detection of non-compliance. In addition, the system database 406 optionally includes a results table 506b, which is used to store the model scores and explanations in association with their detected compliance risk. Generally, the tables are organized around the interactions so that pertinent data for any interaction can be easily looked up or retrieved given representative's identification or other keys.

3. Interaction Selection Process

In order for the system 500 to determine the probability of non-compliance, it must first select the interactions to be analyzed by the predictive model 522; this is primarily done by the interaction selection process 510. The system then accepts interactions for consideration, makes certain determinations about them, and records its conclusions in the scoring file 512. In one embodiment, all interactions that are considered by the interaction selection process 510 are included in the scoring file 512. Those that are excluded from scoring by the predictive model 522 are identified in the scoring file 512 with an exclusion code indicating the reason the interaction was excluded from scoring. The exclusion code is helpful to allow the organization to obtain additional information about the interaction if desired, or pursue other actions with regard to the interaction. Additional selection criteria may be imposed by the variable derivation process 514 to further limit which interactions are analyzed. The rule-based analysis 520 may analyze an interaction even if the interaction selection process 510 or variable derivation process 514 excluded that interaction from being scored. In the rule-based analysis, the interaction selection is performed individually by each rule.

The interaction selection process 510 can support two operational modes:

automated batch mode; and

user-controlled mode.

In automated batch mode, the interaction selection process 510 analyzes each interaction in reference tables 506a. For each interaction, it determines if the interaction information contains sufficient data. If not all required data is available, then the interaction selection process 510 records an exclusion code in the scoring file 512.

In user-controlled mode, the user submits to the interaction selection process 510 a list of scoring candidates to be considered, for instance all interactions within a certain period or involving specific representatives or organizational units.

4. Scoring File

The scoring file 512 is created by the interaction selection process 510 and contains one record for each organizational representative with interactions that the interaction selection process 510 considered. The variable derivation process 514 reads and processes the scoring file 512, passing each record through the predictive model 522 and, if used, the rule-based analysis 520. All records pass through the post-scoring process 524 and are recorded in the results file.

5. Variable Derivation

The variable derivation process 514 uses the data from the scoring file 512 and the system database 406 as well as data from the lookup tables 516 to derive the variables that are used by the predictive model 522 and that may also be used by the rule-based analysis 520. The variables for which values are derived have been previously selected during a training phase as being statistically correlated with non-compliance. The variable derivation process 514 processes each organizational representative in the scoring file 512 individually (one at a time), drawing on data in the system database 406 as needed, and passes the results for that representative to the predictive model 522 and the rule-based analysis 520.

During the variable derivation process 514, various lookup tables 516 may be employed to obtain values for global statistics that are based on historical usage data 400, 406, industry data 402, and third party data 404. For example, the lookup tables 516 may store values for peer group risk variables associated with one or more different classifications of representatives or interactions into peer groups. The values are retrieved from the lookup tables 516 by looking up the appropriate value given the applicable peer group risk value for the representative. Preferably, a given representative is classified as being in multiple different peer groups, with respect to various classification schemes. Thus, a representative may have an industry peer group, a product line peer group, a peer group based on interaction date ranges, and a peer group based on geographic location. The variable derivation process 514 may obtain the appropriate peer group risk variable for each of the peer groups of the representative.

The lookup tables 516 may be subject to an automated update process 518 by which data from the representatives and interactions is used to refine and update the values of the statistics in the tables.

6. Lookup Tables

The lookup tables 516 contain statistical information related to certain factors or variables. These tables are used in the variable derivation process 514 to provide the peer group compliance risk measures for a particular representative or to provide statistics used to calculate peer group comparison variables for a given representative's interactions. Each lookup table uses a certain category or variable relative to a peer group classification scheme as its key and contains estimates of certain statistics determined from historical representatives and interaction data.

Typical examples of the lookup tables contained in pharmaceutical representatives' embodiment of the disclosure include: Peer Group Risk by product type and physician type visited. Each row and column combination of this table contains the non-compliance risk associated with a given promoted product category and physician specialty. Product types describe the classification of a promoted product, such as anti-depressants, diagnostics, etc. Physician type describes the specialty of visited physicians, such as pediatrics, oncologist, or general practitioner.

The statistics in the lookup tables 516 are calculated from historical data about the behavior of organizational representatives and non-compliant behavior observations. Over time, as more historical data accumulates in the system database 406, the lookup tables 516 may be updated. Updating can occur in two ways. New tables can be calculated outside of the system and installed manually or tables can be updated by the system dynamically by automated updated process 518.

If the lookup tables are updated manually, such updates are performed as needed to keep the statistics current with changing patterns of non-compliance or other changes in the data. For example, for off-label marketing, if patterns of non-compliance shifted such that off-label marketing became much more common for a class of products than it was previously, then it would be necessary to update the product types risk tables. The need for manual updates may be determined by monitoring non-compliance patterns and/or the results of the predictive model 522 or a reasonable updating schedule based on past experience may be adhered to. Alternatively, the tables may be updated dynamically on a constant basis via recursive update formulas.

7. Predictive Model

The input variables created by the variable derivation process 514 are input into the predictive model 522 and into the optional rule-based analysis 520 if one is included. These modules of the compliance risk detection engine 410 identify risk in two ways: by the predictive model 522; and by the rule-based analysis 520 if that process is included.

In general, the predictive model 522 accepts the scoring file 512, assesses each representative in that file for suspicion of non-compliance and provides a model score or other value describing the relative likelihood of non-compliance on each representative. The model scores are derived such that the greater the likelihood of non-compliance on a representative, the higher the model score.

In one embodiment, the predictive model 522 is a single back-propagation neural network that uses a selected group of input variables derived by the variable derivation process 514, and outputs a model score for each representative.

In one embodiment, the predictive model 522 is trained using samples of representative, interaction, and non-compliant practices data from one organization. In an alternative embodiment, the predictive model 522 is trained on a large variety of representatives and interactions from multiple organizations. The predictive model is then generally used unmodified by each new organization for assessing its representatives and practices. This approach creates a more robust model because it has the advantage of being trained on more (and often more varied) examples. Also, the statistics in the lookup tables are more stable because they are derived from a larger sample. Finally this approach provides for rapid deployment of the system with each new organization.

8. Rule-Based Analysis

The primary predictive software solution for detecting compliance risk is located in the predictive model 522. The rule-based analysis 520 provides a complementary type of compliance risk detection that determines if certain specific conditions exist that would indicate a problem with specific interactions, the representative, or organizational units. Some of the rules in the rule-based analysis may analyze representatives and interactions that are also scored by the predictive model 522. Other rules may analyze representatives and interactions that are excluded from scoring.

The rule-based analysis 520 contains a number of “red flag” rules that identify specific contradictions or problems in the data for a representatives and interactions that are indicative of non-compliant behavior and hence risk of non-compliance. Where the predictive model 522 yields a continuous model score for each representative, the rule-based analysis 520 typically provides a red flag indicator (Risk/No Risk) of whether a representative's data exhibits certain specific signals of non-compliance.

Some rules, however, may provide a continuous measure of the degree to which the rule is violated. For example, a rule may output the ratio of two interaction factors when the ratio exceeds a predetermined threshold. For example, suppose a pharmaceutical manufacturer wanted to red-flag interactions where the representative expensed more than a certain amount on gifts to a visited physician. The rule would return a “Risk” flag if that total value for gifts was greater than that level.

Some red-flag rules may use data directly from the reference tables 506a instead of or in addition to using the results from the variable derivation process 514. Red flag rules that operate on interactions that were excluded from scoring by the interaction selection process 510 (and therefore were not acted upon by the variable derivation process) preferably rely strictly on data from the reference tables 506a, though in an alternate embodiment, an excluded interaction may still have the variables derived from it, which are used in the rule-based analysis. The red flag rules are customized for each type of non-compliance and may be customized for each organization.

Each rule in the rule based analysis 520 flags any interaction and representative that violate the rule. These flags can be used as complements to the scores from the predictive model 522. The rule-based analysis can also provide valuable additional analysis for interactions and representatives that are scored by the predictive model 522. For example, a representative meeting with physicians outside his territory might be scored by the predictive model 522, but if nothing else about his interactions looks suspicious, it may not score high. The rule-based analysis 520 however would flag such interactions as having a clear-cut, specific problem that is independent of how suspicious the representative's interactions look more generally.

By themselves, the red flag rules are not an efficient or even very effective method for identifying most compliance risks because far too many red flag rules would be needed and the interactions among the various signals of non-compliance would be missed. However, when there is a clear-cut inconsistency pointing to the need for review, red-flag rules serve as useful complements to the primary detection capability provided by the predictive model 522.

10. Post-Scoring Process

The rule-based analysis 520 and the predictive model 522 pass their respective results to the post-scoring process 524. The post-scoring process 524 puts the output into a standard format that is easy for the organization to use to identify potential non-compliance and puts that output into a results file 526.

The post-scoring process 524 may perform calculations that will assist the organization in using the results. For example, in one embodiment of the system, the post-scoring process 524 performs a calculation on each model score to scale the model score into metrics useful to the organization. It converts the model score output of predictive model 522 to a “non-compliance score” that can be interpreted as a probability of non-compliance of the organizational representative and stores that result in results file 526. In one embodiment, the post-scoring process 524 scales the results from the predictive model on a scale from 0 to 500 and inverts the result such that the higher post-scoring results convey less non-compliance risk and the lower post-scoring results mean a greater risk of non-compliance. Such a final score is called Off-Label Marketing Risk Score, or OLM Risk Score, in case of off-label marketing in the pharmaceutical industry. This score represents the expected compliance of the organizational representative with the policies and regulations the organization is subjected to.

The post-scoring process 524 updates the results file 526 which can subsequently update the results table 506b of the system database 406.

11. Results Table

The results table 506b contains one record for each organizational representative that was considered by the interaction selection process 510. In one embodiment, this includes the employee number, the start and end dates of the scoring period, and any information that was added by the compliance risk detection engine 410. That information may include a model score, red-flag indicators, and reason codes. Finally, the table also stores any post-scoring results, as described above under Post-Scoring Process 524, such as the OLM Risk Score. The results table 506b is preferably stored in the system database 406 from which the users can access it, or it may be passed directly to the users through an external interface.

The system 500 as described is preferably implemented in a networked system, in combination with an organizations computer system, a central database, and a separate computer system managed by a provider of the present disclosure as a service to the organization. This configuration detail is not material to the present disclosure.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method of detecting behaviors by organizational representatives that are not compliant with policies, laws, or regulations the organization is subject of, where the representative is acting on behalf of an organization in interactions with customers, suppliers, regulators, employees, or other stakeholders of the organization, the method comprising:
selecting, by one or more computing systems, one or more electronically recorded interactions to process with a predictive model; for each selected representative, deriving variables from the interactions in connection with the selected representative; and
for each selected representative, applying, by one or more computing systems, the delivered variables of the interactions to the predictive model to generate a model score indicating the relative likelihood of non-compliant behavior.

2. The method of claim 1, further comprising:
collecting, by one or more computing systems, training data including one or more interactions leading to the suspicion of non-compliant behaviors and one or more interactions conforming to compliant behaviors; developing, by one or more computing systems, the predictive model from the training data; and storing, by one or more computing systems, the predictive model.

3. The method of claim 2, further comprising:
for interactions determining, by one or more computing systems, the suspicion of non-compliant behaviors by comparing interaction data with direct responses from the interaction counterparts.

4. The method of claim 1, further comprising:
converting, by one or more computing systems, the model score to a non-compliance score indicating the probability of non-compliance by a representative.

5. The method of claim 1, further comprising:
collecting, by one or more computing systems, direct feedback data from an organizational representative, indicating if non-compliant behaviors have occurred during the course of an interaction or if the representative asserts the interactions were compliant.

6. The method of claim 5, further comprising:
collecting feedback data by one or more mobile computing systems connected with other computing systems via wireless networks or direct connection.

7. The method of claim 1, further comprising:
for each of the interactions, storing, by one or more computing systems, the recorded interaction information and model scores in a format that is suitable for providing a compliance audit trail.

8. The method of claim 1, wherein deriving variables from interaction related information further comprises:
determining, by one or more computing systems, one or more peer groups of which the selected interactions are members; and for each peer group or set of peer groups of which the selected interactions are members, deriving, by one or more computing systems, variables from the interaction information which attribute characteristics of the peer group or set of peer groups to the selected interactions, or which compare the selected interactions to interactions in the peer group or set of peer groups.

9. The method of claim 1, wherein deriving variables further comprises:
deriving, by one or more computing systems, variables from the representative's information and interactions which compare the selected representative's interactions in a selected time period with the selected representative's interactions in a time period prior to the selected time period.

10. The method of claim 8, further comprising:
for each of the peer groups, storing, by one or more computing systems, in a lookup table group statistics for interaction characteristics of the interactions in the peer group; and
updating, by one or more computing systems, the lookup table for a peer group of the selected interactions using interaction information of the selected interactions.

11. The method of claim 1, further comprising:
deriving, by one or more computing systems, variables that measure the probability of non-compliance of an interaction based on at least one characteristic of the interaction.

12. The method of claim 1, further comprising:
subjecting, by one or more computing systems, an interaction to one or more decision rules which identify specific or inconsistent facts related to the interaction, to generate an output indicating which decision rules were violated by the interaction.

13. The method of claim 11, wherein the decision rules are derived from statistical analysis of interactions of at least one organization which have been determined to result in non-compliant behavior by representatives.

14. The method of claim 11, where the interactions are sales calls and wherein the decision rules are selected from a group consisting of:
a decision rule that identifies as potentially non-compliant an interaction that conveys information not sanctioned by an organization;
a decision rule that identifies as potentially non-compliant an interaction that conveys untruthful information;
a decision rule that identifies as potentially non-compliant an interaction taking place outside the usual setting of conducting sales calls;
a decision rule that identifies as potentially non-compliant an interaction that involves expense reimbursement requests of amounts outside the normative limits set by the organization;
a decision rule that identifies as potentially non-compliant an interaction that involves the exchange of samples in amounts outside the normative limits set by the organization;
a decision rule that identifies as potentially non-compliant an interaction with a counter part not on the call plan of the representative;
a decision rule that identifies as potentially non-compliant an interaction outside the boundaries of the representative's usual territorial boundaries;
a decision rule that identifies as potentially non-compliant an interaction that does not contain required interaction recording data; and
a decision rule that identifies as potentially non-compliant an interaction that does include a reporting of non-compliant exchanges.

15. The method of claim 1, further comprising:
for each selected representative, determining, by one or more computing systems, at least one variable which significantly contributes to the model score for the included interactions; and
outputting, by one or more computing systems, a reason for the model score associated with the determined one or more variables.

16. A system for detecting behaviors not compliant with policies, laws, or regulations, comprising:
a database of interactions, each interaction associated with a representative of an organization and having interaction related data; and
a computer system that implements:
An interaction selection process that selects from the database a number of interactions for scoring;
A variable derivation process that derives for each of the selected interactions variables associated with the representative, who conducted the interaction, for comparison with peer group interactions; and
A compliance risk detection module that receives for each representative the derived variables and generates a score indicating the likelihood of non-compliant behavior by the representative.

17. The system of claim 16, wherein the compliance risk detection module further comprises:
a predictive model that generates a model score indicating a relative likelihood of non-compliance of interactions of an organizational representative; and
a post scoring process that converts the model score into a compliance risk score indicating the probability of non-compliance by the organizational representative.

18. The system of claim 17, the computer system further implementing:
a rule-based process that applies one or more rules to selected interactions to identify suspected non-compliance based on inconsistent or incomplete interaction related information.

19. A method of developing a predictive model of non-compliance, the method comprising:
collecting, by one or more computing systems, from at least one organization interaction information for one or more organizational representatives;
selecting a training set of interactions;
deriving, by one or more computing systems, for each interaction in the training set one or more variables from the interaction information or from other information relevant to compliance determination; and
applying, by one or more computing systems, the derived variables to an untrained predictive model to produce a measure with respect to whether one or more organizational representatives pose a risk of non-compliance.

20. The method of claim 19, further comprising:
tagging, by one or more computing systems, each of the interactions to indicate whether the interaction is compliant, non-compliant, or indeterminate; and
selectively adjusting the interactions tagged by one or more computing systems.
